(19) United States
(12) Patent Application Publication
(10) Pub. No.: US 2007/0228035 A1
(43) Pub. Date: Oct. 4, 2007

(54) Warmer for tortillas and the like

(76) Inventor: Jorge Islas, LaPuente, CA (US)

Correspondence Address: Boniard I. Brown, 1710 West Cameron Ave., #200, West Covina, CA, 91790, US

(21) Appl. No.: 11/392,280

(22) Filed: Mar. 30, 2006

(51) Int. Cl. H05B 6/80

(52) U.S. Cl. 219/725

(57) ABSTRACT

A microwavable container for transporting heated materials such as tortillas from a heating apparatus to a location for consumption. Each of a plurality of tortilla trays is connected with one of spaced-apart rods integral with or secured to the trays, and maintains tortillas or the like separated to prevent their sticking together.

### BACKGROUND OF THE INVENTION

Problems are involved maintaining tortillas and the like separate from each other during and after being heated in a microwave or the like and while being transported to a location for consumption. The present invention maintains tortillas and the like warm and separate until consumed to avoid them sticking to each other, for periods such as forty-five minutes, at a dining location or picnic site. The device of the invention is adapted to bend or flex spaced-apart trays thereof for insertion and withdrawal of tortillas. Trays are spaced apart for insertion and withdrawal of tortillas and the like, and the trays are grooved or comprise screens to prevent tortillas and the like from attaching to the trays.

### BRIEF DESCRIPTION OF THE DRAWINGS

FIG. 1 is a perspective view of a tortilla warmer according to the invention;

FIG. 2 is a sectional view of a bent tortilla warmer tray bearing a tortilla thereon;

FIG. 3 is a sectional view taken at line 3-3 in FIG. 1, showing a plurality of trays supporting tortillas and showing rods engaging respective clip members;

FIG. 4 is a perspective view of a plurality of tortilla trays in relation to supporting rods and hook members;

FIG. 5 is a sectional view taken at line 5-5 in FIG. 4; and

FIG. 6 is a perspective view similar to that of FIG. 4 showing an alternate arrangement wherein screen members are substituted for the trays of the embodiment of FIG. 4.

### DETAILED DESCRIPTION OF THE INVENTION

The present invention relates generally to a microwavable heat retentive container for transportation of heated material, typically tortillas, from a microwave apparatus or the like wherein heated material, typically tortillas, are preferably maintained apart to prevent their sticking to each other.

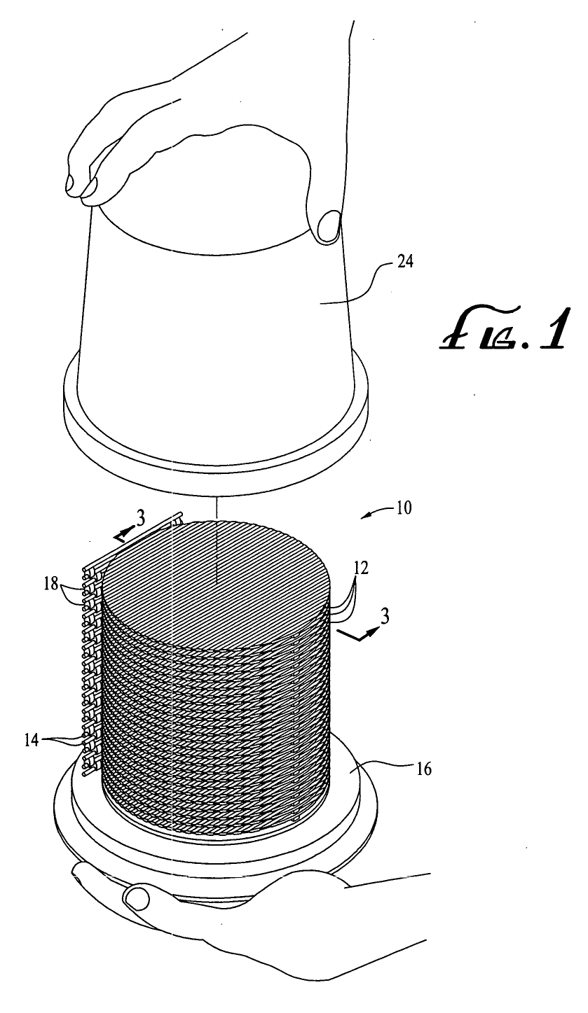

Referring to the drawings, a preferred embodiment of the invention is shown in FIGS. 1, 2 and 3 as comprising a container 10 having a plurality of tortilla trays 12, each of which is connected with one of a plurality of spaced-apart rods 14, typically formed of molded plastic, which rods 14 are integral with or secured to the trays, as shown. The container of the invention may typically be cylindrical in configuration, having a cover 24, and is, preferably mounted on a base 16 as shown.

The apparatus of the invention is adapted to carry heated items, typically tortillas, and to maintain them heated and separated until utilized, typically at a dining table, picnic site, etc. Tortillas and the like may typically thus be maintained appropriately warm for a period such as forty-five minutes.

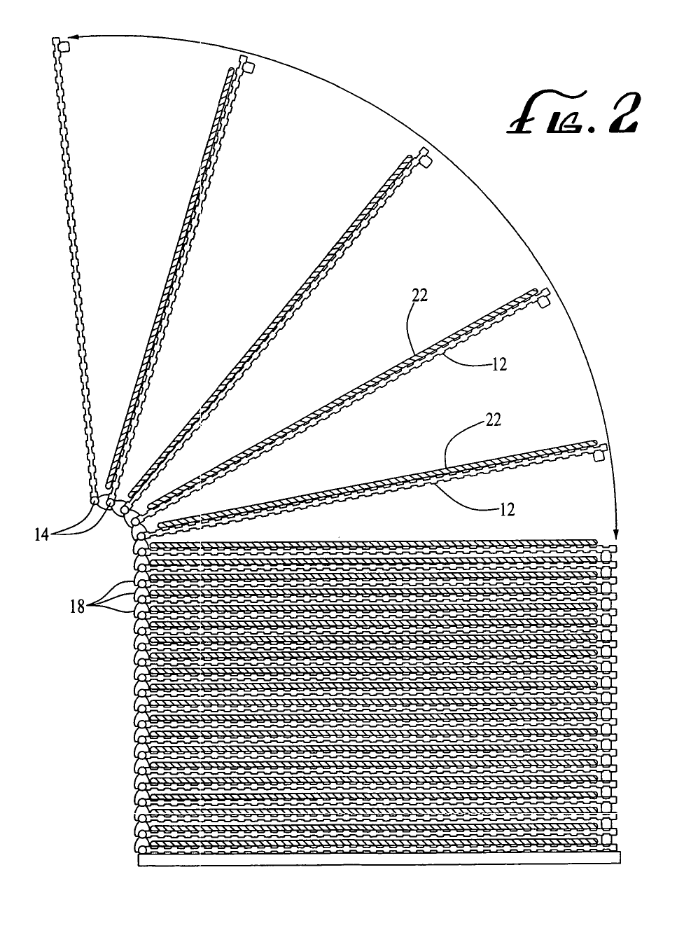

As shown in FIG. 2, the apparatus of the invention is adapted to bend or flex so that respective trays 12 thereof are spaced apart for the insertion or withdrawal of tortillas relative to the trays. A person may pull in a sidewise direction to pivot and spread apart the trays 12, then pull tortillas out or insert them.

Snap clip members 18 are snap fitted and retained on the end portions of respective trays 12 so that the clip members will not become disengaged or unsnapped. The trays 12 have grooves 20 therein to prevent items carried on the trays, typically tortillas 22, from sticking or attaching to the trays, the trays having ridges defined therein to define passages under tortillas 22 to aid in preventing the adhesion of tortillas to the trays.

The present invention addresses the problems involved in the moving of tortillas and the like after heating thereof, as in a microwave or over, to a location for consumption of the tortillas, as at a table, picnic area, etc.

A common method of maintaining the temperature of tortillas is simply to re-heat them. However, this is inconvenient and time-consuming, and can prevent a person handling the tortillas between an oven and a dining location from joining other persons in dining.

Preferably, a container for tortillas is formed of plastic foam or the like in order to maintain the tortillas warm long enough for transport thereof to a position for consumption.

The warming of tortillas presents the problem of tortillas adhering to each other, thereby often making it difficult to separate tortillas without tearing them apart.

According to the invention, tortillas and the like are maintained separately positioned on respective trays for heating, the trays having a multiplicity of grooves and ridges to enable the escape of steam and vapor to prevent tortillas and the like from becoming excessively moist.

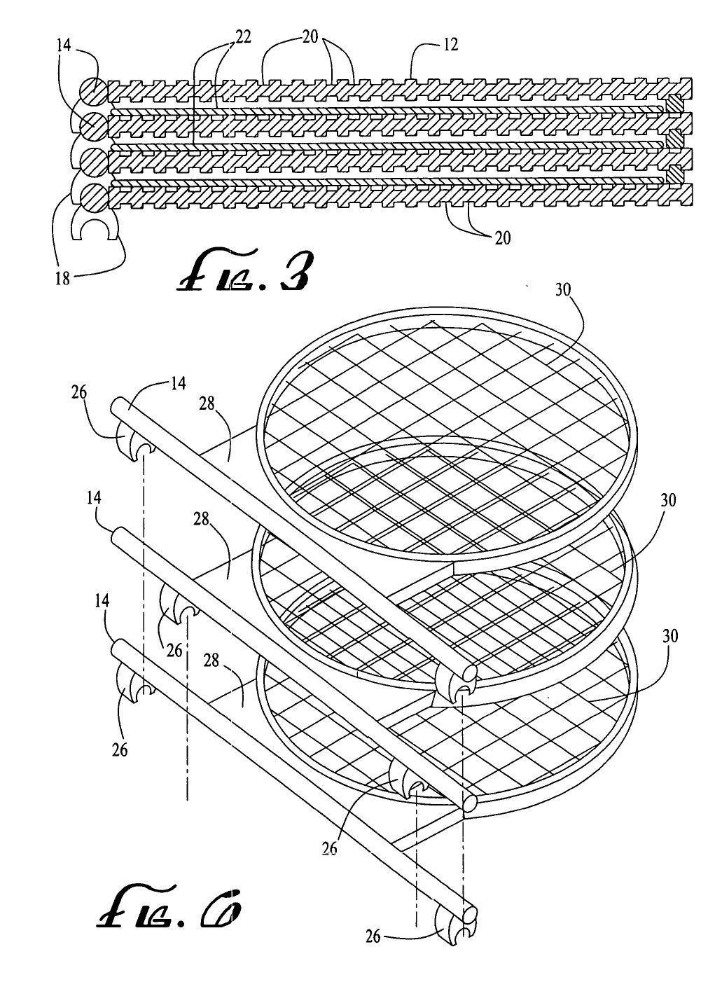

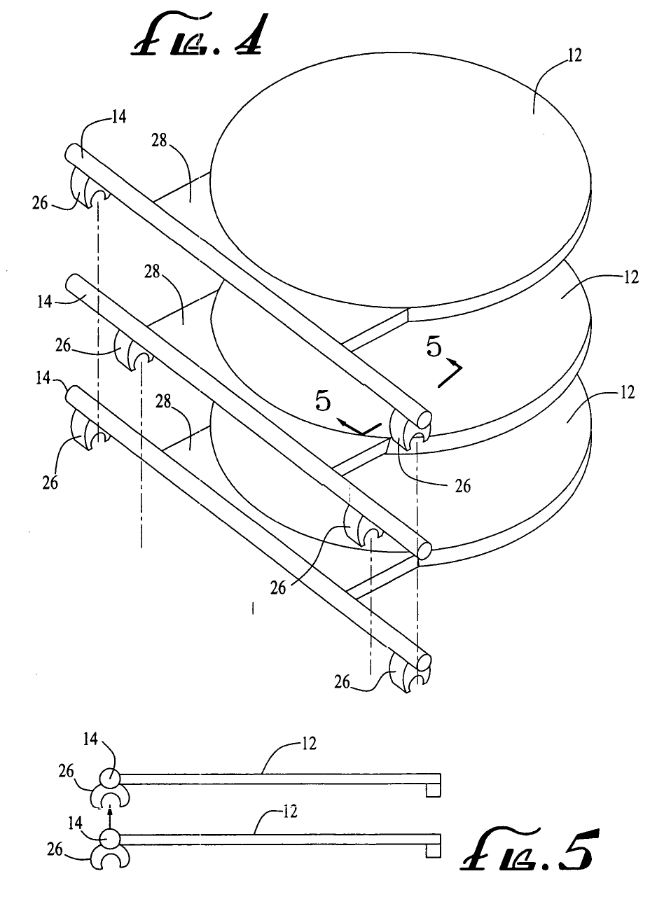

FIGS. 4 and 5 show an assembly for utilization with the embodiment shown in FIGS. 1 to 3.

The rod components 14 are disposed in stacked array, as shown in FIG. 1.

Referring to FIG. 4, hook members 26 on respective rods are in vertical alignment, with lower ones spaced apart.

The plate elements 28 in FIGS. 4 and 6 are formed integrally with the trays and are disposed between respective rods and trays.

The hook elements 26 are adapted to receive the rods, in a snap-fit arrangement, as shown in FIGS. 4 and 6.

FIG. 6 shows an embodiment similar to that of FIG. 4. and which differs therefrom in that the trays 30 thereof define screen structures instead of the solid tray member of FIG. 4.

It will be understood that various changes and modifications may be made from the preferred embodiment discussed above without departing from the scope of the present invention, which is established by the following claims and equivalents thereof.

I claim:

1. A carrier maintains tortillas and the like separate during heating as in a microwave and comprises:
a plurality of trays in generally stacked array to receive tortillas thereon,
groove means defined in at least a plurality of said trays to vent moisture therefrom,
a plurality of rods attached to respective trays and pivotal therewith, and
a plurality of clip members respective ones of which are secured on the end portions of respective rods.

2. A carrier according to claim 1 wherein said respective rods and clips are force-fitted together.

3. A carrier according to claim 1 wherein said carrier has an outer shell formed of polypropylene.

4. A carrier according to claim 1 wherein said trays are pivotal relative to said rods at the ends of the trays.

5. A carrier according to claim 1 and further comprising spacer members disposed on respective trays to separate and space them apart at their ends opposite from said rods.

6. A carrier according to claim 1 wherein respective ones of said trays are mounted for separate movement thereof for insertion and removal of tortillas relative to the trays.

7. A carrier according to claim 1 and further comprising spacers on the outer end portions of at least a plurality of trays to hold apart their end portions opposite from said rod.

8. A carrier according to claim 1 wherein the trays are pivotable relative to said clip members to spread apart adjacent trays.

9. A carrier maintains tortillas and the like separate during heating as in a microwave, and comprises:
a plurality of vertically spaced aligned rods,
a snap clip member disposed adjacent to each of the opposite end portions of each of the rods,
a plate member secured to and extending from each of said rods, and
a tray for tortillas and the like extending from each of said plates on the side thereof opposite one of said rods secured to the same plate.

10. An assembly according to claim 9 wherein said respective rods are integrally formed with the respective plates.

11. An assembly according to claim 9 wherein said respective clip members extend downwardly from respective ones of said rods.
